(19) United States
(12) Patent Application Publication
(10) Pub. No.: US 2014/0004388 A1
(43) Pub. Date: Jan. 2, 2014

(54) BATTERY PACK AND CASE

(71) Applicant: SAMSUNG SDI CO., LTD., Yongin-si (KR)

(72) Inventor: Bohyun Byun, Yongin-si (KR)

(73) Assignee: SAMSUNG SDI CO., LTD., Yongin-si (KR)

(21) Appl. No.: 13/754,581

(22) Filed: Jan. 30, 2013

(30) Foreign Application Priority Data
Jul. 2, 2012 (KR) 10-2012-0071884

(51) Int. Cl. H01M 10/42

(52) U.S. Cl. CPC H01M 10/425
USPC 429/7

(57) ABSTRACT

A battery pack and a case are disclosed. The battery pack includes a bare cell, a protection circuit module electrically connected to the bare cell, and a case covering the protection circuit module and having at least one portion bent to be disposed between the bare cell and the protection circuit module. The battery pack is adapted to save cost and time of the manufacturing the battery pack.

### CLAIM OF PRIORITY

This application makes reference to, incorporates the same herein, and claims all benefits accruing under 35 U.S.C. §119 from an application earlier filed in the Korean Intellectual Property Office on 2 Jul. 2012 and there duly assigned Ser. No. 10-2012-0071884.

### BACKGROUND OF THE INVENTION

1. Field of the Invention

Embodiments of the present invention relate to a battery pack and a case of the battery pack, and more particularly, to a battery pack and a case of the battery pack which prevent short circuit between a secondary protection device and other electrical components.

2. Description of the Related Art

Secondary batteries are rechargeable batteries, and the secondary batteries are variously applied to different portable electrical devices such as mobile phones, notebook computers, and camcorders.

A secondary battery may include a bare cell which has an electrode assembly, a can accommodating the electrode assembly, and a cap assembly coupled to an opening of the can to be electrically connected to external terminals. Such a secondary battery may further include a protection circuit module electrically connected to the bare cell, and a case covering the protection circuit module, thereby constituting a battery pack. The protection circuit module controls over-discharging and over-charging of the bare cell. The protection circuit module may include a protection device such as a positive temperature coefficient (PTC) device and a thermal fuse. The protection device is referred to as a secondary protection device discriminated from a primary protection device such as a safety vent of the bare cell.

To prevent short circuit between such a secondary protection device installed on a protection circuit module and other electrical circuit parts, or unnecessary short circuit between the protection circuit module and the bare cell, a polyethylene telephthalate (PET) tape may be attached to the top surface of the bare cell on which the protection circuit module is installed.

The attachment of such a short circuit prevention tape to the bare cell however requires additional man power, higher material costs, and longer manufacturing process time.

### SUMMARY OF THE INVENTION

In order to solve the above mentioned problems, an aspect of the present invention provides a battery pack and a case of the battery pack, which are adapted for saving cost and time of the manufacturing process.

In accordance with one embodiment of the present invention, a battery pack may include a bare cell; a protection circuit module electrically connected to the bare cell; and a case covering the protection circuit module and having at least one portion bent to be disposed between the bare cell and the protection circuit module.

The case may include a cover plate covering an upper part of the protection circuit module; multiple side walls arrayed along a boundary of the cover plate to cover a side part of the protection circuit module; and a short circuit prevention part extended from at least one portion of an end of the side wall, and bent to be disposed between a surface of the bare cell and the protection circuit module.

A bending recess may be disposed along a boundary between the side wall and the short circuit prevention part.

The side walls may include a pair of longer side walls disposed along longer sides of the cover plate, and facing each other; and a pair of shorter side walls disposed along shorter sides of the cover plate, and facing each other. The short circuit prevention part is extended from one of the longer side walls, and is bent.

The short circuit prevention part may be provided in plural, and the short circuit prevention parts may be spaced apart from each other along a longitudinal direction of the longer side walls.

The side walls may include a pair of longer side walls disposed along longer sides of the cover plate, and facing each other; and a pair of shorter side walls disposed along shorter sides of the cover plate, and facing each other. The short circuit prevention part is provided in plural, and the short circuit prevention parts are extended from the longer side walls, respectively, and are bent from the longer side walls, respectively.

The short circuit prevention parts may be arrayed in an offset form on the longer side walls.

The bare cell may include an electrode assembly, a can accommodating the electrode assembly, and a cap plate sealing the can. The short circuit prevention part may be disposed between the protection circuit module and the cap plate.

The protection circuit module may include electrode parts to electrically connect to the bare cell, and the short circuit prevention part may be disposed between the electrode parts.

In accordance with another embodiment of the present invention, a case is coupled to a bare cell of a battery pack to cover a protection circuit module of the battery pack which is electrically connected to the bare cell. The case may include a cover plate; multiple side walls arrayed along a boundary of the cover plate; and a short circuit prevention part extended from at least one portion of an end of the side wall, and bendable toward the cover plate.

A bending recess may be disposed along a boundary between the side wall and the short circuit prevention part.

When the bare cell electrically connected to the protection circuit module is coupled to the case, the cover plate may cover an upper part of the protection circuit module, and the side wall may cover a side part of the protection circuit module, and the short circuit prevention part may be disposed between a surface of the bare cell and the protection circuit module.

The side walls may include a pair of longer side walls disposed along longer sides of the cover plate, and facing each other; and a pair of shorter side walls disposed along shorter sides of the cover plate, and facing each other. The short circuit prevention part is extended from one of the longer side walls, and is bent from one of the longer side walls

The short circuit prevention part may be provided in plural, and the short circuit prevention parts may be spaced apart from each other along a longitudinal direction of the longer side walls.

The side walls may include a pair of longer side walls disposed along longer sides of the cover plate, and facing each other; and a pair of shorter side walls disposed along shorter sides of the cover plate, and facing each other. The short circuit prevention part is provided in plural, and the short circuit prevention parts are extended from the longer side walls, respectively, and are bent from the longer side walls, respectively.

The short circuit prevention parts may be arrayed in an offset form on the long side walls.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an oblique view illustrating a battery pack constructed with the principle of an embodiment of the present invention;

FIG. 2 is an exploded oblique view illustrating the battery pack of FIG. 1;

FIG. 3 is a partial cut-away oblique view taken along line of FIG. 1;

FIG. 4 is a partial cut-away oblique view taken along line IV-IV′ of FIG. 1;

FIGS. 5A and 5B are cross-sectional views illustrating a method of bending short circuit prevention parts of FIG. 1; and

FIG. 6 is an oblique view illustrating a case constructed with the principle of another embodiment of the present invention.

### DETAILED DESCRIPTION OF THE INVENTION

Korean Patent Application No. 10-2012-0071884 filed on Jul. 02, 2012, in the Korean Intellectual Property Office, and entitled: “BATTERY PACK AND CASE” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

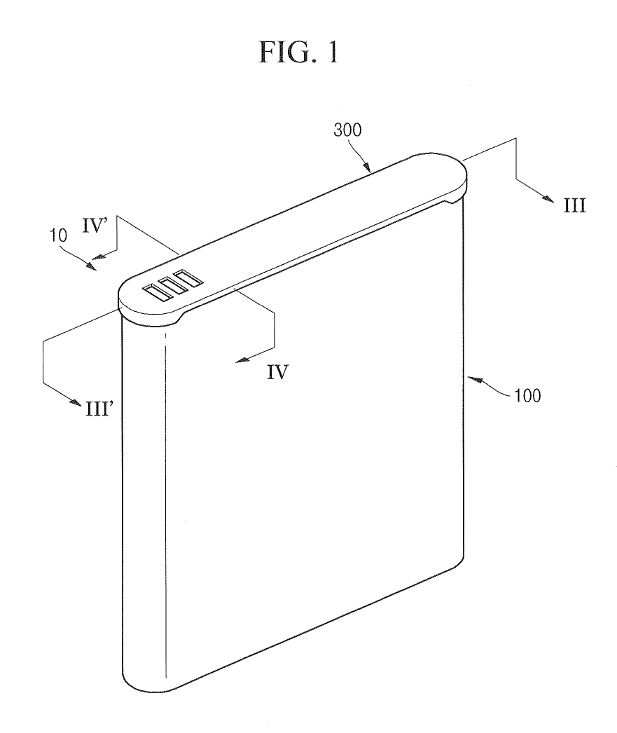

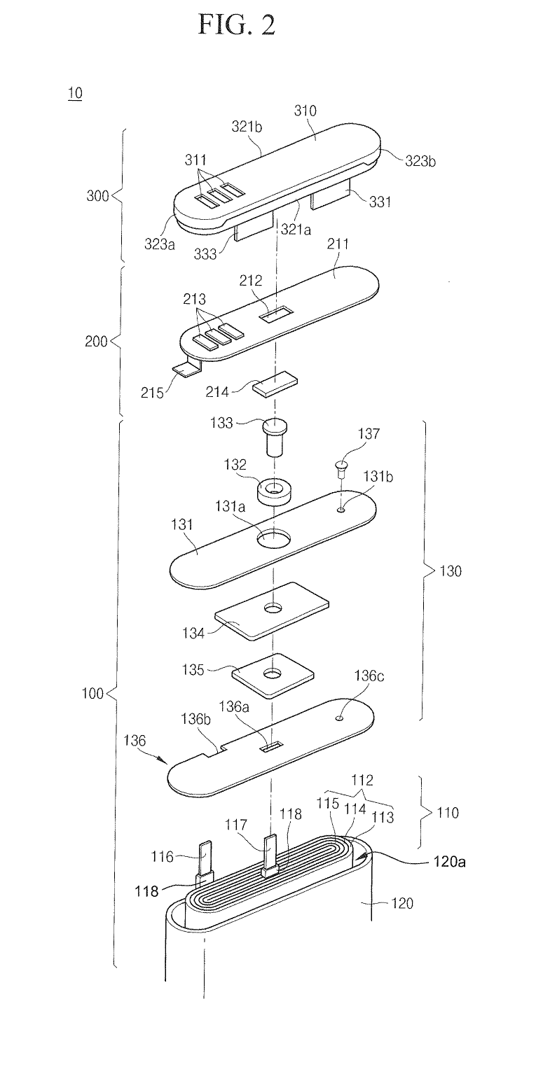

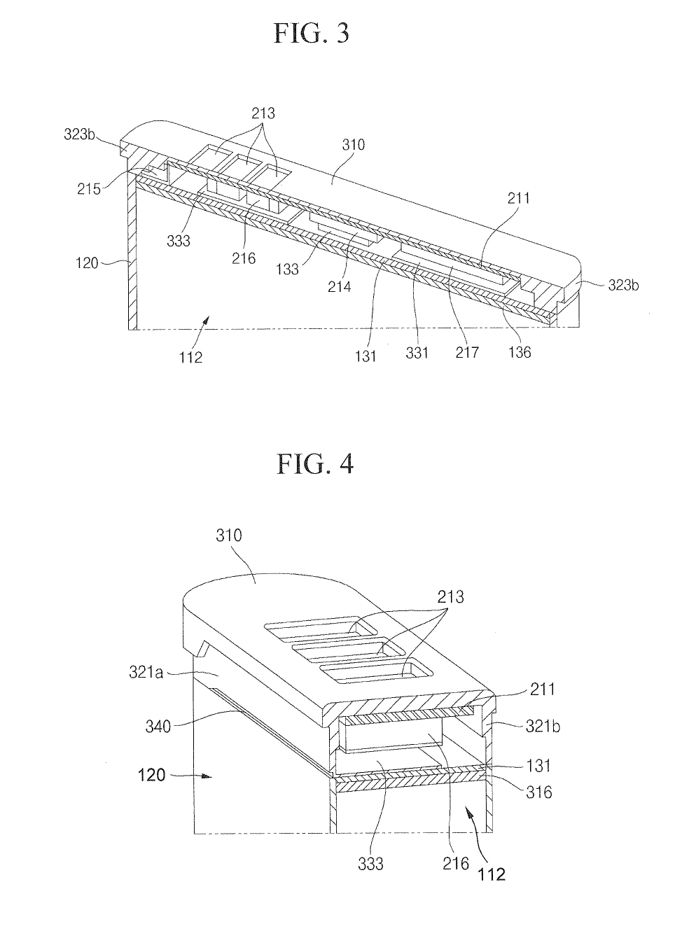

FIG. 1 is an oblique view illustrating a battery pack 10 constructed with the principle of an embodiment of the present invention. FIG. 2 is an exploded oblique view illustrating the battery pack 10 of FIG. 1. FIG. 3 is a partial cut-away oblique view taken along line of FIG. 1. FIG. 4 is a partial cut-away oblique view taken along line IV-IV′ of FIG. 1.

In reference to FIGS. 1 through 4, the battery pack 10 includes a bare cell 100; a protection circuit module 200 electrically connected to the bare cell 100; and a case 300 coupled to the bare cell 100 to cover the protection circuit module 200. Since the case 300 is coupled substantially to the upper part of the bare cell 100, the case 300 will be referred to as a top case in order to clarify the current embodiment.

The bare cell 100 may include a can 120, an electrode assembly 112 accommodated in the can 120, and a cap assembly 130 sealing an opening of the can 120.

The can 120 has an approximately rectangular parallelepiped shape with both curved short side surfaces, and is a metal container having an upper opening 120a, which may be formed through deep drawing. Thus, the can 120 may function as a terminal of the battery. The can 120 may be formed of aluminum or an aluminum alloy as a lightweight conductive metal. The can 120 functions as a container accommodating the electrode assembly 112 and electrolyte. The opening 120a of the can 120 through which the electrode assembly 112 is inserted is sealed with the cap assembly 130.

The electrode assembly 112 may include a positive electrode plate 113, a separator 114, and a negative electrode plate 115. Further, the electrode assembly 112 may include a positive electrode tab 116 leading out from the positive electrode plate 113; a negative electrode tab 117 leading out from the negative electrode plate 115; and insulating tapes 118 attached to the positive and negative electrode tabs 116 and 117. The insulating tapes 118, wound around the positive and negative electrode tabs 116 and 117, are disposed on a boundary of the electrode assembly 112 from which the positive and negative electrode tabs 116 and 117 lead out.

The positive electrode plate 113 and the negative electrode plate 115 are stacked with the separator 114 therebetween, and are wound in a spiral shape, that is, in a so-called jelly roll shape. The positive electrode plate 113 may be formed by coating a collector of an aluminum foil with a lithium cobalt oxide as a positive electrode active material. The negative electrode plate 115 may be formed by coating a collector of a copper foil with graphite as a negative electrode active material. The separator 114 may be formed of polyethylene, polypropylene, or a co-polymer of polyethylene and polypropylene. The separator 114 may be wider than the positive electrode plate 113 and the negative electrode plate 115 to prevent short circuit between the positive and negative electrode plates 113, 115.

The cap assembly 130 includes a cap plate 131, a gasket 132, an electrode terminal 133, an insulating plate 134, a terminal plate 135, and an insulating plate 136.

The cap plate 131 has a terminal through hole 131 a in the central part thereof to receive the electrode terminal 133. The gasket 132 is disposed on the outer circumference of the electrode terminal 133 to electrically insulate the electrode terminal 133 from the cap plate 131. The cap plate 131 has an electrolyte injection hole 131b in a side thereof to inject electrolyte into the can 120. The electrolyte injection hole 131b is sealed with a plug 137 after electrolyte is injected.

The electrode terminal 133 is electrically connected to the negative electrode tab 117, and functions as a negative terminal; in this case, the can 120 may function as a positive terminal. In another embodiment, when the electrode terminal 133 is connected to the positive electrode tab 116, the electrode terminal 133 functions as a positive terminal; in this case, the can 120 may function as a negative terminal. In the current embodiment, the electrode terminal 133 functions as a negative terminal.

The insulating plate 134 is disposed on the bottom surface of the cap plate 131, and the terminal plate 135 is disposed on the bottom surface of the insulating plate 134. Thus, the insulating plate 134 electrically insulates the cap plate 131 and the terminal plate 135 from each other.

The terminal plate 135 is coupled to the lower end of the electrode terminal 133. The negative electrode plate 115 of the electrode assembly 112 is electrically connected to the terminal plate 135 and the electrode terminal 133 through the negative electrode tab 117. The positive electrode plate 113 of the electrode assembly 112 is electrically connected to the cap plate 131 through the positive electrode tab 116 welded to the bottom surface of the cap plate 131.

The insulating plate 136 is disposed on the top surface of the electrode assembly 112. The insulating plate 136 has a negative electrode tab through part 136a, a positive electrode tab through part 136b, and an electrolyte injection hole 136c.

After electrolyte is injected into the can 120 through the electrolyte injection hole 131b formed in the cap plate 131, the electrolyte injection hole 131b is sealed with the plug 137.

The protection circuit module 200 may include a board body 211 and a secondary protection device 217 installed on the board body 211 (FIG. 3).

The board body 211 has a hole 212 in the central part thereof. External terminals 213 are mounted on a surface (the top surface) of the board body 211 to discharge electric current to the outside. A charging/discharging control device (not shown) may be mounted on another surface (the bottom surface) of the board body 211. An electrode terminal 214 is disposed on the lower end of the hole 212 disposed in the central part of the board body 211. A lead plate 215 is disposed on a side end of the bottom surface of the board body 211. The electrode terminal 214 may function as a negative terminal, and the lead plate 215 may function as a positive terminal. Alternatively, the electrode terminal 214 may function as a positive terminal, and the lead plate 215 may function as a negative terminal.

A positive temperature coefficient (PTC) device is used as the secondary protection device 217. Alternatively, a protection device equivalent to the PTC device may be used as the secondary protection device 217, but the secondary protection device 217 is not limited thereto.

The protection circuit module 200 is electrically connected to the bare cell 100. A spot welding process for coupling the electrode terminal 214 to the electrode terminal 133 of the bare cell 100 is performed through the hole 212 of the board body 211. The lead plate 215 is coupled to the top of the bare cell 100, that is, to the cap plate 131 through laser welding. When the electrode terminal 133 is a negative terminal, the cap plate 131 functions as a positive terminal of the bare cell 100. At least one portion of the lead plate 215 disposed on the top surface of the cap plate 131 is electrically connected to a positive terminal of the board body 211.

The top case 300 may include a cover plate 310, side walls 321a, 321b, 323a, and 323b, and a plurality of short circuit prevention parts 331 and 333.

The cover plate 310 may have an approximately oval plate shape, and cover the upper part of the protection circuit module 200. The cover plate 310 may have terminal holes 311 corresponding to the external terminals 213 of the protection circuit module 200 to expose the external terminals 213.

The side walls 321a, 321b, 323a, and 323b are arrayed along a boundary of the cover plate 310, and extend perpendicularly from the cover plate 310 to cover the side part of the protection circuit module 200. In addition, the side walls 321a, 321b, 323a, and 323b are coupled to the upper part of the bare cell 100.

The side walls 321a, 321b, 323a, and 323b may include first and second longer side walls 321a and 321b and first and second shorter side walls 323a and 323b. The first and second longer side walls 321a and 321b are disposed along longer sides of the boundary of the cover plate 310, and face each other. The first and second shorter side walls 323a and 323b are disposed along shorter sides of the boundary of the cover plate 310, and face each other.

The short circuit prevention parts 331 and 333 are extended from ends of the side walls 321a, 321b, 323a, and 323b, and are bent to be disposed between the bare cell 100 and the protection circuit module 200.

For example, the short circuit prevention parts 331 and 333 may include first and second short circuit prevention parts 331 and 333 that may be individually disposed on an end of the first long side wall 321a. In this case, each of the first and second short circuit prevention parts 331 and 333 may be extended in a plate shape from the end of the first long side wall 321a, and be bent from the end of the first long side wall 321a to the inside of the top case 300. That is, the first and second short circuit prevention parts 331 and 333 may be bent toward the bottom surface of the cover plate 310. A surface of each of the first and second short circuit prevention parts 331 and 333 may be attached to the top surface of the cap plate 131 of the bare cell 100 by an adhesive. Thus, the first and second short circuit prevention parts 331 and 333 are disposed between the cap plate 131 and the protection circuit module 200.

The first and second short circuit prevention parts 331 and 333 are separated from each other to prevent interference with the lead plate 215 and the electrode terminals 133 and 214. For example, the first and second short circuit prevention parts 331 and 333 may be spaced apart from each other along the longitudinal direction of the first longer side wall 321a, so that the electrode terminals 133 and 214 can be disposed in a space formed between the first and second short circuit prevention parts 331 and 333. The first and second short circuit prevention parts 331 and 333 are spaced apart from the lead plate 215. Thus, the first and second short circuit prevention parts 331 and 333 may be disposed not only between the cap plate 131 and the protection circuit module 200, but also between the lead plate 215 and the electrode terminals 133 and 214.

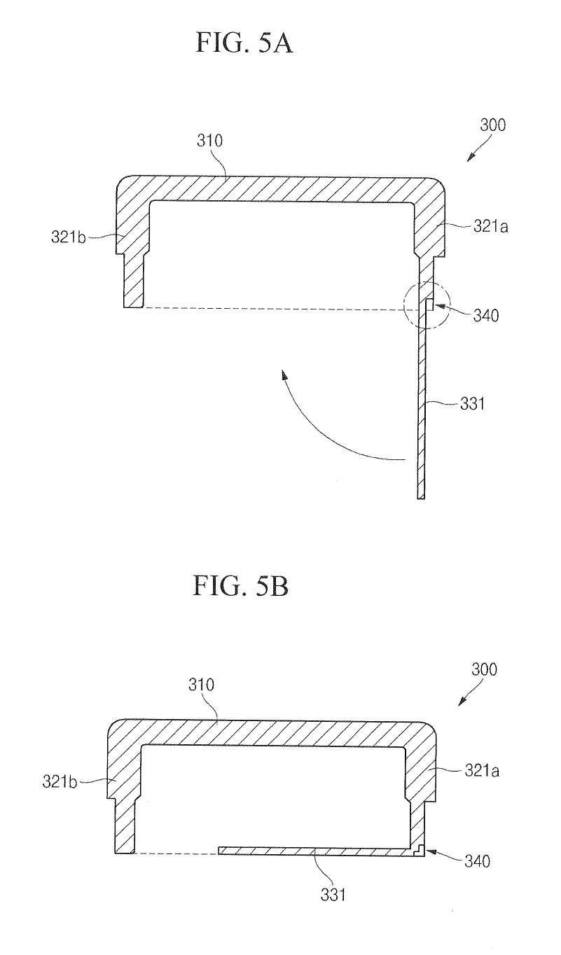

FIGS. 5A and 5B are cross-sectional views illustrating a method of bending the short circuit prevention parts 331 and 333.

In reference to FIG. 5A, a bending recess 340 may be disposed along a boundary between the first short circuit prevention part 331 and the first longer side wall 321a of the top case 300. That is, the bending recess 340 may be disposed along the boundary between the first longer side wall 321a and the first short circuit prevention part 331, and be extended in a line shape along the longitudinal direction of the first longer side wall 321a. The bending recess 340 is disposed in the outer part of the top case 300 to bent the first short circuit prevention part 331 to the inside of the top case 300.

In reference to FIG. 5B, the first short circuit prevention part 331 may be bent to the inside of the top case 300 by means of the bending recess 340.

In one embodiment, the short circuit prevention parts may be formed of electrically insulating material.

In one embodiment, the top case 300 may be formed simultaneously as a single and monolithic body, and the top case 300 may include the cover plate 310, the side walls 321a, 321b, 323a and 323b, and the short circuit prevention parts 331 and 333.

In one embodiment, the top case may be formed of electrically insulating material.

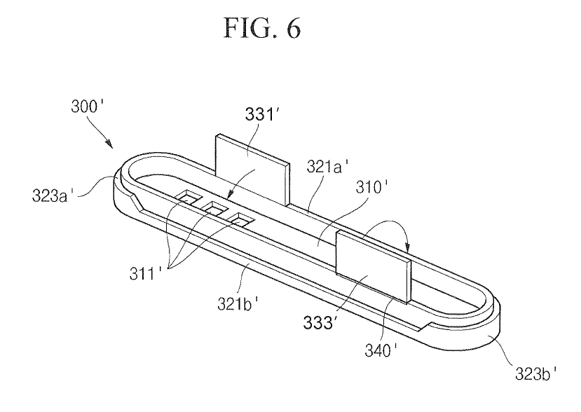

FIG. 6 is an oblique view illustrating a top case 300′ constructed with the principle of another embodiment of the present invention.

The top case 300′ is different from the top case 300 of FIGS. 1 to 4 in the positions of short circuit prevention parts 331′ and 333′.

In reference to FIG. 6, the top case 300′ may include a cover plate 310′, a plurality of side walls 321a′, 321b′, 323a′, and 323b′, and a plurality of the short circuit prevention parts 331′ and 333′. Since the cover plate 310′ and the side walls 321a′, 321b′, 323a′, and 323b′ have the same configuration as that of the cover plate 310 and the side walls 321a, 321b, 323a, and 323b, a detailed description thereof will be omitted.

The short circuit prevention parts 331′ and 333′ may include first and second short circuit prevention parts 331′ and 333′. The first short circuit prevention part 331′ may be disposed on a first longer side wall 321a′, and the second short circuit prevention part 333′ may be disposed on a second longer side wall 321b′, and vice versa. The first and second short circuit prevention parts 331′ and 333′ may be arrayed in an offset form on the first and second long side walls 321a′ and 321b′ facing each other. In the offset form, for example, a portion of the second longer side wall 321b′, which faces the first short circuit prevention part 331′ disposed on the first longer side wall 321a′, has no short circuit prevention part. In addition, a portion of the first longer side wall 321a′, which faces the second short circuit prevention part 333′ disposed on the second longer side wall 321b′, has no short circuit prevention part. One of bending recesses 340′ may be disposed in a boundary between the first longer side wall 321a′ and the first short circuit prevention part 331′, and the other one of the bending recesses 340′ may be disposed in a boundary between the second longer side wall 321b′ and the second short circuit prevention part 333′.

As described above, when the first and second short circuit prevention parts 331′ and 333′ are arrayed in an offset form, the top case 300′ can be coupled to the bare cell 100 in a more balanced way.

According to the embodiments, since a structure integrally formed with a case is bent to be disposed in a region susceptible to short circuit, it may be unnecessary to attach a typical short circuit prevention tape to the region. Thus, additional man power, material costs, and process time for forming and attaching a short circuit prevention tape can be saved.

According to the embodiments, the cost and time of manufacturing the battery pack may be saved.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

What is claimed is:

1. A battery pack, comprising:
a bare cell;
a protection circuit module electrically connected to the bare cell; and
a case covering the protection circuit module and comprising at least one portion bent to be disposed between the bare cell and the protection circuit module.

2. The battery pack as claimed in claim 1, with the case comprising:
a cover plate covering an upper part of the protection circuit module;
a plurality of side walls arrayed along a boundary of the cover plate to cover a side part of the protection circuit module; and
a short circuit prevention part extended from at least one portion of an end of the side walls, and bent to be disposed between a surface of the bare cell and the protection circuit module.

3. The battery pack as claimed in claim 2, wherein a bending recess is disposed along a boundary between the side walls and the short circuit prevention part.

4. The battery pack as claimed in claim 2, with the side walls comprising:
a pair of longer side walls disposed along longer sides of the cover plate, and facing each other; and
a pair of shorter side walls disposed along shorter sides of the cover plate, and facing each other,
with the short circuit prevention part being extended from one of the longer side walls, and being bent from the one of the longer side walls.

5. The battery pack as claimed in claim 4, wherein the short circuit prevention part is provided in plural, and the short circuit prevention parts are spaced apart from each other along a longitudinal direction of the longer side walls.

6. The battery pack as claimed in claim 2, with the side walls comprising:
a pair of longer side walls disposed along longer sides of the cover plate, and facing each other; and
a pair of shorter side walls disposed along shorter sides of the cover plate, and facing each other,
with the short circuit prevention part being provided in plural, and the short circuit prevention parts being extended from the longer side walls, respectively, and the short circuit prevention parts being bent from the longer side walls, respectively.

7. The battery pack as claimed in claim 6, wherein the short circuit prevention parts are arrayed in an offset form on the longer side walls.

8. The battery pack as claimed in claim 2, wherein the bare cell comprises an electrode assembly, a can accommodating the electrode assembly, and a cap plate sealing the can, and
the short circuit prevention part is disposed between the protection circuit module and the cap plate of the bare cell.

9. The battery pack as claimed in claim 2, wherein the protection circuit module comprises electrode parts to electrically connect to the bare cell, and
the short circuit prevention part is disposed between the electrode parts.

10. A case coupled to a bare cell of a battery pack to cover a protection circuit module of the battery pack which is electrically connected to the bare cell, the case comprising:
a cover plate;
a plurality of side walls arrayed along a boundary of the cover plate; and
a short circuit prevention part formed simultaneously together with the side walls and the cover plate as a single and monolithic body, the short circuit prevention part extended from at least one portion of an end of the side walls and bendable toward the cover plate.

11. The case as claimed in claim 10, wherein a bending recess is disposed along a boundary between the side walls and the short circuit prevention part.

12. The case as claimed in claim 10, wherein when the bare cell electrically connected to the protection circuit module is coupled to the case, the cover plate covers an upper part of the protection circuit module, and the side walls cover a side part of the protection circuit module, and the short circuit prevention part is disposed between a surface of the bare cell and the protection circuit module.

13. The case as claimed in claim 10, with the side walls comprising:
a pair of longer side walls disposed along longer sides of the cover plate, and facing each other; and
a pair of shorter side walls disposed along shorter sides of the cover plate, and facing each other,
with the short circuit prevention part being extended from one of the longer side walls and being bent from the one of the longer side walls.

14. The case as claimed in claim 13, wherein the short circuit prevention part is provided in plural, and the short circuit prevention parts are spaced apart from each other along a longitudinal direction of the longer side walls.

15. The case as claimed in claim 10, with the side walls comprising:
a pair of longer side walls disposed along longer sides of the cover plate, and facing each other; and
a pair of shorter side walls disposed along shorter sides of the cover plate, and facing each other,
with the short circuit prevention part being provided in plural, and the short circuit prevention parts being extended from the longer side walls, respectively, and the short circuit prevention parts being bent from the longer side walls, respectively.

16. The case as claimed in claim 15, wherein the short circuit prevention parts are arrayed in an offset form on the longer side walls.

17. A battery pack, comprising:
a bare cell;
a protection circuit module electrically connected to the bare cell, the protection circuit module comprising external terminals extruding away from the bare cell; and
a case covering a surface of the protection circuit module from which the external terminals protrude, the case being formed simultaneously as a single and monolithic body, and the case comprising a portion bent to be disposed between the bare cell and the protection circuit module.

18. The battery pack of claim 17, with the case comprising:
a cover plate;
a side wall extended from a periphery of the cover plate; and
a short circuit prevention part extended from an end of the side wall and bent to be disposed between the bare cell and the protection circuit module.
